(19) United States
(12) Patent Application Publication
(10) Pub. No.: US 2008/0109382 A1
(43) Pub. Date: May 8, 2008

(54) Method And System For Computer-Based Portfolio Protection For Security Transactions

(75) Inventor: Sina Pyghambarzadeh, Los Angeles, CA (US)

Correspondence Address: PERKINS COIE LLP, P.O. BOX 2168, MENLO PARK, CA, 94026, US

(73) Assignee: Sina Pyghambarzadeh, Los Angeles, CA (US)

(21) Appl. No.: 11/763,161

(22) Filed: Jun. 14, 2007

Related U.S. Application Data
(60) Provisional application No. 60/856,278, filed on Nov. 3, 2006.
(60) Provisional application No. 60/856,277, filed on Nov. 3, 2006.

(51) Int. Cl. G06Q 40/00

(52) U.S. Cl. 705/36 R

(57) ABSTRACT

A novel approach provides automatic security protection for individual investors, either at the time of a transaction of a security, or after the transaction has been made. More specifically, a button or other similar kind of acceptance component is placed on a web page of the transaction, which allows for the simultaneous purchase of a protection (“insurance”) and the security transaction. The option and function of such protection is explained clearly in “plain English” to the investor at the time of purchase. Alternatively, an individual investor's security portfolio can be analyzed, and protection for the portfolio for a given amount of time can be offered.

### RELATED APPLICATIONS

This application claims priority to U.S. Provisional Patent Application No. 60/856,278 filed Nov. 3, 2006, and entitled “Automated computer-based portfolio protection for equities transactions,” by Sina Pyghambarzadeh, and is hereby incorporated herein by reference.

This application claims priority to U.S. Provisional Patent Application No. 60/856,277 filed Nov. 3, 2006, and entitled “Peace of mind portfolio insurance; method and process,” by Sina Pyghambarzadeh, the contents of which application are hereby incorporated by reference.

### BACKGROUND

1. Field of Invention

This invention relates to the field of online security transaction.

2. Background of the Invention

Web-based security trading is becoming increasingly popular in recent years as more and more individual investors trade securities online by themselves without assistance from a live broker. Here, a security can be, but is not limited to, a stock, a bond, a future, a commodity, and any other kind of publicly traded equity. Since many of these investors trading online are not professional traders, they often purchase securities with the hope that the prices of the securities they purchased will appreciate over time, without being fully aware of the risks inherent in their security portfolios. Although derivatives (options) have been widely used by professionals in the financial industry to hedge or reduce security risks, most individual investors do not know about the intricacies of the derivatives, nor do they know how to structure appropriate hedges with the right combination of calls, puts, deltas, betas, strike prices, or expiration dates. There is certainly a gap between the investors' need for protection and what has been made available to meet such need.

### SUMMARY OF INVENTION

A novel approach provides automatic security protection for individual investors, either at the time of a transaction of a security, or after the transaction has been made. More specifically, a button or other similar kind of acceptance component is placed on a web page of the transaction, which allows for the simultaneous purchase of protection (“insurance”) and the security transaction. The function of such protection is explained clearly in “plain English” to the investor at the time of purchase. Alternatively, an individual investor's security portfolio can be analyzed, and protection for the portfolio for a given amount of time can be offered.

### BRIEF DESCRIPTION OF THE DRAWINGS

FIG. 1 is an illustration of an exemplary system to provide protection for security transactions.

FIGS. 2(a)-(b) are flow charts illustrating exemplary processes to provide protection for security transactions.

### DETAILED DESCRIPTION OF EMBODIMENTS OF THE INVENTION

The invention is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A novel approach is enabled to provide security protection for individual investors, either at the time of a transaction of a security, or after the transaction has been made. More specifically, a button or other similar kind of acceptance component is placed onto an online security transaction page, which allows for the simultaneous purchase of protection on the security transaction. Here, such protection or hedge can be an implementation of buying a protective put (or call) simultaneously with the purchase (or sale) of a security. The function of such protection is explained clearly in “plain English” to the investor at the time of purchase. Alternatively, an individual investor's security portfolio can be analyzed, and protection of the portfolio for a given amount of time can be offered for a specific price. Such an approach enables the investors to trade securities with a peace of mind knowing that they are guaranteed a minimum payout even if their investments experience a downturn for any reason. Although the approach ideally targets “passive” investors who trade infrequently and generally buy and hold a security position for at least 3 months, appropriate hedges can be structured for other investors as well, wherein such investors can be but are not limited to active investors or ultra-passive investors.

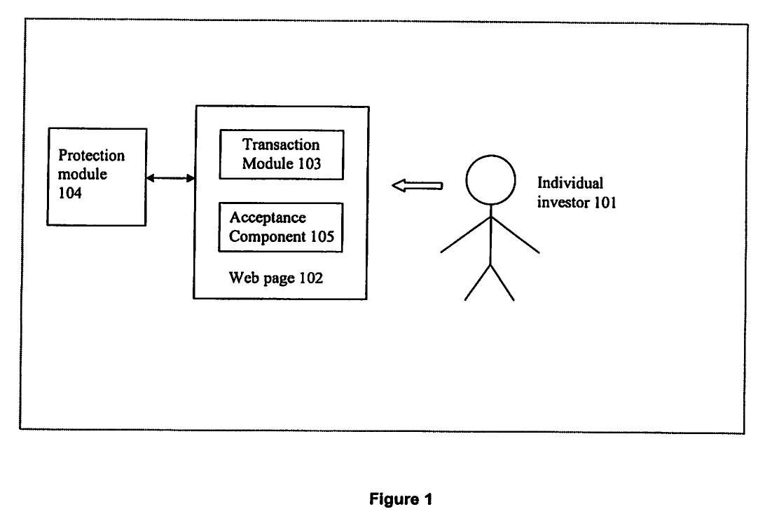

FIG. 1 is an illustration of an exemplary system to provide protection for security transactions. Although this diagram depicts components as functionally separate, such depiction is merely for illustrative purposes. It will be apparent to those skilled in the art that the components portrayed in this figure can be arbitrarily combined or divided into separate software, firmware and/or hardware components. Furthermore, it will also be apparent to those skilled in the art that such components, regardless of how they are combined or divided, can execute on the same computing device or multiple computing devices, and wherein the multiple computing devices can be connected by one or more networks.

Referring to FIG. 1, a transaction module 103 is operable to enable a party (an individual investor) 101 to submit the request for the transaction of the security via a web page 102. A protection module 104 is operable to accept a request for a transaction of a security from the party, review the transaction of the security and design a hedge to protect the transaction. The hedge can then be offered to the party initiating the transaction presented to the party and explained to the party in plain English at the time of the transaction. If the party decides to take the protection offered, an acceptance component 105 is operable to enable the party to accept the hedge at time the transaction of security is submitted. Here, the acceptance component can be a button on the same web page 102 where the party submits the request for the transaction. Once the party clicks the button, the protection module 104 is further operable to execute the transaction and the hedge simultaneously to insure that the transaction of the security is protected. Alternatively, the protection module 103 may accept an existing security portfolio holding one or more securities, scan the portfolio and design one or more hedges to protect the one or more securities in the portfolio.

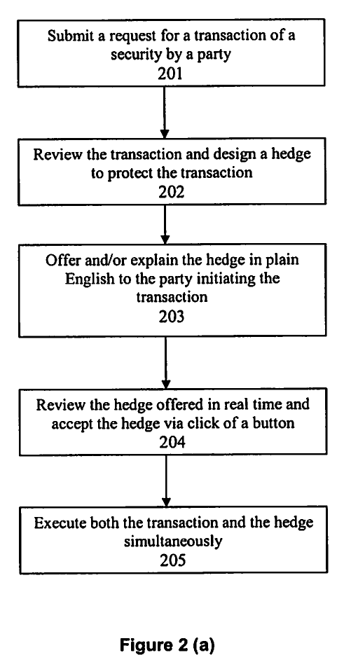

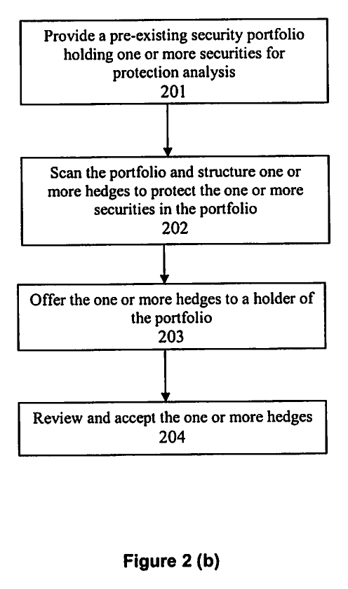

FIGS. 2(a)-(b) are flow charts illustrating exemplary processes to provide protection for security transactions. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

Referring to FIG. 2(a), a request for a transaction of a security can be submitted by a party at step 201. The transaction is reviewed and a hedge to protect the transaction is designed at step 202. At step 203, the hedge is offered and/or explained in plain English to the party initiating the transaction. At step 204, the party may review the hedge offered in real time and accept the hedge via click of a button. Both the transaction and the hedge can then be executed simultaneously at step 205.

Alternatively, protection for a pre-existing security portfolio can be offered post-execution, i.e., after all the securities in the portfolio have been purchased. Referring to FIG. 2(b), a pre-existing security portfolio holding one or more securities can be provided for protection analysis at step 201. The portfolio can then be scanned and one or more hedges to protect the one or more securities in the portfolio can be structured at step 202. At step 203, the one or more hedges can be offered to a holder of the portfolio, and the holder of the portfolio may review and accept the one or more hedges at step 204.

For a non-limiting example, if there is an investor named Mr. Smith with a given portfolio of 100 shares each of five different stocks, the portfolio can be scanned and a hedge can be designed and offered to Mr. Smith. Such protection can be explained along the lines of, “Mr. Smith, for $250 you can protect your portfolio for 3 months, and guarantee a minimum payout in case the market goes down. Would you like to purchase this protection?” At that point, Mr. Smith could elect to purchase the protection.

Using the processes described above, security transactions and/or portfolio of an individual investor can be protected with a customized derivative approach, which guarantees a minimum payout to the individual investor on a given stock or portfolio for a given amount of time even if securities in the portfolio diminish in value. On the other hand, the party offering the protection to the investor will not lose any money regardless of what does or does not happen to the portfolio because the premium paid for the derivative (plus transaction costs) is covered by the fee the investor paid.

In some embodiments, the protection (hedging) offered can be explained in a simple way in “plain English” relating to the commonly understood concept of “insurance” to individual investors who may lack derivative knowledge and expertise to understand options or other derivatives sufficiently to hedge their own portfolios. For a non-limiting example, when a hypothetical customer named Mr. Jones may use a website of an online brokerage firm to effect a purchase of 100 shares of Microsoft Corporation, an additional service is offered as a button or other similar device on the same page where Mr. Jones would ordinarily execute the purchase, which the investor could “click” on to protect that purchase for a certain period of time for a specific fee. In addition, the investor will be prompted with the following statement in plain English—“Mr. Jones, we can guarantee that you will be alright if your 100 shares of Microsoft plummet within 3 months. If your Microsoft goes below $25 per share, you will still get $25 per share, even if Microsoft goes to $15 per share. This is something we can guarantee to you for 3 months for a service cost of $30.” At that point, Mr. Jones could “click” the button to add the protection onto his original purchase of 100 shares of Microsoft stock. Here, the “service cost” above can be simply derived from the market rates for protective derivatives (options) on the securities being insured. Other deals and more complex transactions similar in nature can also be constructed and proposed.

In some embodiments, once clicked, the “button” for purchase of protection would use the transaction execution technology and processes the online brokerage already provides, i.e., the “button” would have the effect of “bundling” the purchase of the equities with an appropriate number of derivatives. In the non-limiting example discussed above, if Mr. Jones could “click” the button to add the protection onto his original purchase of 100 shares of Microsoft stock, the purchase of the 100 shares of stock would essentially be “bundled” with one put option, simultaneously, thus protecting the investor for a given amount of time. From Mr. Jones' perspective, he would simply pay a slightly higher service fee and receive the satisfaction of knowing that he has a guaranteed minimum payout on the stock just purchased. Here, portfolio protection is offered in lots of 100 shares and ten units of protection would be needed if the investor owns 1,000 shares of Microsoft shares.

In some embodiments, the protection on the investor's security portfolio can be offered by a third party and/or on a website completely independent of the investor's online brokerage. Once the investor provides the third party with information on his/her security transaction/portfolio, a hedge (or protection) can be designed for the investor's portfolio and offered for a fee to the investor.

In some embodiments, the following phases of a transaction would take place to a prospective individual investor who indicates interest in security/portfolio protection: design and offer of a hedge, execution of the hedge, and periodic re-offering of the hedge (when the current hedge expires).

### Design and Offer of a Hedge

In some embodiments, a fully customized hedge can be offered to protect a security portfolio of an individual investor, wherein each security position/transaction in the portfolio can be hedged initially on an individual basis, with a perfect one-to-one correlation between derivatives (hedges) offered and the number of security positions. In other words, there will be one hedge set up for each security position. The tactic is to purchase an appropriate number of put (or call) options to cover or hedge a given investor's equity positions. For a non-limiting example, a put option can be offered for a given duration (e.g. 3 months) on a given underlying security (e.g. 100 shares of Cisco) at a predetermined price.

In some embodiments, risk of security transactions can be pooled with hedges structured for several investors and security transactions at a time as the number of protected investors and hedged security transactions grows. Such a risk pooling approach groups investors into subsets, each with investors having similar portfolios, and utilizes one or more index options to hedge security positions much more cost-effectively. For a non-limiting example, puts on an entire index (i.e. the NASDAQ) can be purchased at much lower prices and transaction costs than puts on individual securities. Furthermore, index options have the highest liquidity on the market in terms of derivatives, which is beneficial. Note that purchase of index options does involve some risk, however, since the security portfolio of each individual investor may be over- or under-weighted in a given security that differs from the index. For a non-limiting example, if investors have 75% of their portfolios invested in Cisco stocks, and the index selected as the hedge has a much lower percentage of Cisco stocks, the hedge may need some fine-tuning. Under this situation, additional derivatives may need to be purchased on a given underlying security (Cisco stocks in this case) to balance out the hedge.

### Execution of the Hedge

Once the hedge protection is designed and offered to an individual investor in simple terms, and accepted by the investor after he/she understood the hedge, the derivates required to hedge the portfolio of the investor will be executed (purchased).

In some embodiments, the derivatives purchased to hedge the investor's portfolio may not be placed in the same account where the underlying securities being protected are held. In other words, the derivatives can be purchased and held in an account on behalf of the investor separate from the investor's own account at his or her online brokerage. If the investor wishes to “cash in” (exercise) the hedge, the derivatives can be sold to pay the investor an amount agreed upon when the portfolio protection was initiated. In the non-limiting example of a put option, the minimum price of a put option is greater than the difference in the strike price and the price of the underlying security. If the price of the underlying stock drops to the point when the investor wishes to “cash in” on his or her protection on the stock, the price of the put option would have appreciated high enough to make this possible. The put option can simply be sold on the open market (at the market price or better, depending on trading conditions) and enough cash from this transaction can be collected to make a minimum payout as agreed upon to the investor that “makes him/her whole.” In other words, the investor receives an amount of cash that is equivalent to having sold the stock at the predetermined price, i.e., his or her portfolio is protected exactly as he or she had agreed to initially. On the other hand, if the price of the underlying stock does not diminish in value to the point that the investor wishes to “cash in” the protection, then the put option simply expires worthless.

### Periodic Re-Offering of the Hedge

In some embodiments, an investor who purchased protection for a certain period of time (e.g., three months) on a given security that has not dropped in price during that period of time may be offered to renew his/her hedge protection. Alternatively, if the investor wishes to renew his or her protection before the current hedge expires, a new derivative can be purchased on his/her behalf and the current hedge can possibly be sold before it expires to generate extra profit. For a non-limiting example, if an investor has purchased a three-month protection on Cisco stocks, he/she will be offered a renewal of the policy two weeks before the current protection expires. At that point, the investor can renew his or her protection for another three months, or for a longer period of six months or more based on pricing of the protections offered (for non-limiting examples, the three-month protection may cost $50, while the six-month policy may cost $120).

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more computing devices to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Particularly, while the concept “module” is used in the embodiments of the systems and methods described above, it will be evident that such concept can be interchangeably used with equivalent concepts such as, class, method, type, interface, bean, component, object model, and other suitable concepts. While the concept “component” is used in the embodiments of the systems and methods described above, it will be evident that such concept can be interchangeably used with equivalent concepts such as, class, method, type, interface, bean, module, object model, and other suitable concepts. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

What is claimed is:

1. A system to provide protection for security transactions, comprising:
a protection module operable to:
accept a request for a transaction of a security from a party;
review the transaction of the security and design a hedge to protect the transaction; and
offer the hedge to the party initiating the transaction; and
an acceptance component operable to enable the party to accept the hedge at time of the transaction.

2. The system of claim 1, further comprising:
a transaction module operable to enable the party to submit the request for the transaction of the security via a web page.

3. The system of claim 2, wherein:
the acceptance component is a button on the same web page where the party submits the request for the transaction of the security.

4. The system of claim 2, wherein:
the transaction module is provided by an online brokerage.

5. The system of claim 4, wherein:
the protection module is provided by a third party independent from the online brokerage.

6. The system of claim 1, wherein:
the security is one of: a stock, a bond, a future, and a commodity.

7. The system of claim 1, wherein:
the hedge is a call or put option.

8. The system of claim 1, wherein:
the hedge provides a minimum payout amount if exercised during certain period of time.

9. The system of claim 1, wherein:
the protection module is further operable to execute the transaction and the hedge simultaneously.

10. The system of claim 9, wherein:
The hedge is held at a separate account from the security once executed.

11. The system of claim 1, wherein:
the protection module is further operable to explain the hedge to the party in plain English at time of the transaction.

12. The system of claim 1, wherein:
the protection module is further operable to offer the hedge to the party for a service cost.

13. The system of claim 1, wherein:
the protection module is further operable to renew offering of the hedge to the party after certain period of time.

14. A system to provide protection for security portfolios, comprising:
a protection module operable to:
accept an existing security portfolio, wherein the portfolio holds one or more securities;
scan the portfolio and design one or more hedges to protect the one or more securities in the portfolio; and
offer the one or more hedges to a holder of the portfolio; and
an acceptance component operable to enable the holder of the portfolio to accept the one or more hedges.

15. The system of claim 14, wherein:
the protection module is further operable to execute the one or more hedges to protect the one or more securities in the portfolio.

16. The system of claim 14, wherein:
the protection module is further operable to structure one hedge for each of the one or more securities in the portfolio.

17. The system of claim 14, wherein:
the protection module is further operable to protect the one or more securities in the portfolio with one or more index options.

18. A method to provide protection for security transactions, comprising:
submitting a request for a transaction of a security;
reviewing a hedge offered to protect the transaction of a security in real time; and
accepting the hedge via click of a button.

19. A method to provide protection for security transactions, comprising:
accepting a request for a transaction of a security;
reviewing the transaction of the security and designing a hedge to protect the transaction;
offering the hedge to a party initiating the transaction; and
enabling the party to accept the hedge at time of the transaction.

20. The method of claim 19, further comprising:
executing the transaction and the hedge simultaneously.

21. The method of claim 20, further comprising:
holding the hedge and the security in separate accounts once executed.

22. The method of claim 19, further comprising:
explaining the hedge to the party in plain English at time of the transaction.

23. The method of claim 19, further comprising:
offering the hedge to the party for a service cost.

24. The method of claim 19, further comprising:
renewing offering of the hedge to the party after certain period of time.

25. A method to provide protection for security portfolios, comprising:
providing a security portfolio for protection analysis, wherein the portfolio holds one or more securities;
reviewing one or more hedges offered to protect the one or more securities in the portfolio; and
accepting the one or more hedges.

26. A method to provide protection for security portfolios, comprising:
accepting a security portfolio, wherein the portfolio holds one or more securities;
scanning the portfolio and structuring one or more hedges to protect the one or more securities in the portfolio; and
offering the one or more hedges to a holder of the portfolio; and
enabling the holder of the portfolio to accept the one or more hedges.

27. The method of claim 26, further comprising:
executing the one or more hedges to protect the one or more securities in the portfolio.

28. The method of claim 26, further comprising:
structuring one hedge for each of the one or more securities in the portfolio.

29. The method of claim 26, further comprising:
protecting the one or more securities in the portfolio with one or more index options.

30. A machine readable medium having instructions stored thereon that when executed cause a system to:
accept a request for a transaction of a security;
review the transaction of the security and design a hedge to protect the transaction;
offer the hedge to a party initiating the transaction; and
enable the party to accept the hedge at time of the transaction.

31. A system to provide protection for security portfolios, comprising:
means for accepting a security portfolio, wherein the portfolio holds one or more securities;
means for scanning the portfolio and structuring one or more hedges to protect the one or more securities in the portfolio; and
means for offering the one or more hedges to a holder of the portfolio; and
means for enabling the holder of the portfolio to accept the one or more hedges.
